(19) United States
(12) Patent Application Publication
(10) Pub. No.: US 2026/0153948 A1
(43) Pub. Date: Jun. 4, 2026

(54) SCROLL WHEEL CONTROL SYSTEM AND SCROLL WHEEL CONTROL METHOD

(71) Applicant: RUI LI, SHENZHEN (CN)

(72) Inventor: RUI LI, SHENZHEN (CN)

(21) Appl. No.: 19/456,004

(22) Filed: Jan. 22, 2026

(30) Foreign Application Priority Data
Jul. 28, 2025 (CN) 202511042058.7

(51) Int. Cl. G06F 3/0362; G06F 3/038; G06F 3/0485

(52) U.S. Cl. CPC G06F 3/0362; G06F 3/038; G06F 3/0485

(57) ABSTRACT

A scroll wheel control system and a scroll wheel control are provided. The scroll wheel control system includes a base. A rotating shaft is disposed on the base. A scroll wheel is rotatably disposed on the rotating shaft. At least one magnet is disposed on the scroll wheel. At least one magnetic sensor is disposed on the base. A distance between the at least one magnet and the at least one magnetic sensor changes when the scroll wheel rotates to different angles. The at least one magnetic sensor is electrically connected to a conversion control module. The conversion control module converts a magnetic field variation and a variation rate sensed by the at least one magnetic sensor into a change amount and a change speed of a control operation.

### TECHNICAL FIELD

The present disclosure relates to a field of human-computer interaction devices, and in particular to a smooth scroll wheel control system and a smooth scroll wheel control method that achieves a high-precision smooth scrolling effect by real-time detection of a scrolling speed of a scroll wheel thereof.

### BACKGROUND

Most mouse scroll wheels on the market currently adopt a mechanical detent mechanism, typically with 24 notches per rotation or a similar step-based design. While such structure provides basic scrolling feedback, its limited scrolling resolution often fails to accurately capture a user's scrolling intent during slow or subtle-angle scrolling. Especially on operating systems like macOS, mouse scroll wheels fall far short of the smooth animation transitions and nuanced scrolling responses of Apple trackpads. Furthermore, conventional scroll wheel systems are unable to detect changes in a scrolling speed and a scrolling angle in real time, resulting in scrolling animations that fail to responsively follow user input. Moreover, the conventional scroll wheel systems generally produce a “stuttering,” “jumping,” or other unnatural scrolling experience, which significantly impacts usability for high-end office users and content creators.

### SUMMARY

To address problems in the prior art, the present disclosure provides a smooth scroll wheel control system and a scroll wheel control method that achieves a high-precision smooth scrolling effect.

The present disclosure provides a scroll wheel control system. The scroll wheel control system comprises a base. A rotating shaft is disposed on the base. A scroll wheel is rotatably disposed on the rotating shaft. At least one magnet is disposed on the scroll wheel. At least one magnetic sensor is disposed on the base. A distance between the at least one magnet and the at least one magnetic sensor changes when the scroll wheel rotates to different angles. The at least one magnetic sensor is electrically connected to a conversion control module. The conversion control module converts a magnetic field variation and a variation rate sensed by the at least one magnetic sensor into a change amount and a change speed of a control operation.

In one optional embodiment, the at least one magnetic sensor is a Hall sensor.

In one optional embodiment, a main control chip is disposed on the base, and the main control chip comprises the conversion control module.

In one optional embodiment, a main control chip is disposed on the base, and the main control chip is electrically connected to the conversion control module.

In one optional embodiment, the scroll wheel is connected to a damping feedback device.

In one optional embodiment, the scroll wheel is a mouse scroll wheel, and the conversion control module converts the magnetic field variation and the variation rate sensed by the at least one magnetic sensor into a movement distance and a speed of a mouse control interface.

The present disclosure further provides a scroll wheel control method. The scroll wheel control method comprises steps:
rotating the scroll wheel, collecting a rotation angle and a rotation speed of the scroll wheel in real-time by at least one sensor;
sending, by the at least one sensor, collected rotation angle and rotation speed data of the scroll wheel to a conversion control module; and
generating, by the conversion control module, a scrolling inertial animation according to the collected rotation angle and rotation speed data of the scroll wheel.

In one optional embodiment, the conversion control module uses the collected rotation angle and rotation speed data of the scroll wheel to deduce a user's intent in real time.

In one optional embodiment, the conversion control module is configured to determine a scrolling state of the scroll wheel as slow/medium/fast based on the collected rotation angle and rotation speed data of the scroll wheel, and the conversion control module is further configured to calculate scrolling data for the scrolling state based on scrolling parameters configured on a host.

In one optional embodiment, the at least one sensor is at least one magnetic sensor.

The at least one magnet is mounted on the rotating shaft, and the at least one magnetic sensor is fixed to one side of the rotating shaft to collect scroll wheel rotation information in real time and transmit the scroll wheel rotation information to the conversion control module. The conversion control module sends scrolling events to the host for interaction with a host system, dynamically controlling a scrolling animation. The present disclosure achieves smooth animation transitions and precise scrolling responses through real-time signal acquisition by the at least one magnetic sensor, accurately capturing scrolling intents of a user. Furthermore, the present disclosure eliminates any “stuttering,” “jumping,” or unnatural scrolling experience during user operation, improving a user experience for high-end office users and content creators.

### BRIEF DESCRIPTION OF DRAWINGS

FIG. 1 is a schematic diagram of a scroll wheel control system according to one embodiment of the present disclosure.

FIG. 2 is a schematic diagram of the scroll wheel control system according to another embodiment of the present disclosure.

FIG. 3 is a flow chart of a scroll wheel control method according to one embodiment of the present disclosure.

### DETAILED DESCRIPTION

With reference to the embodiments and accompanying drawings, the present disclosure is further described in detail below.

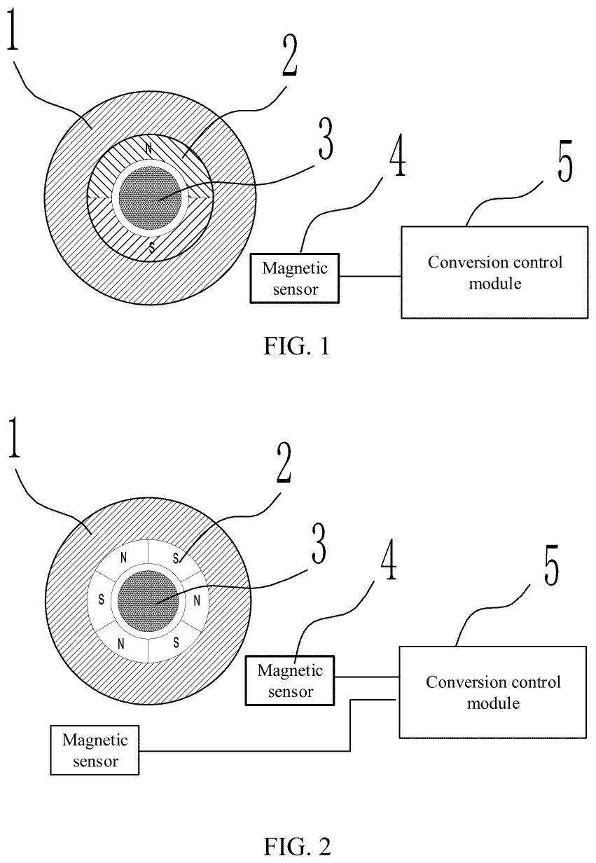

The present disclosure provides a scroll wheel 1 control system. As shown in FIGS. 1-2, the scroll wheel 1 control system comprises a base (not shown in the figures). A rotating shaft 3 is disposed on the base. A scroll wheel 1 is rotatably disposed on the rotating shaft 3. At least one magnet 2 is disposed on the scroll wheel 1. At least one magnetic sensor 4 is disposed on the base. A distance between the at least one magnet 2 and the at least one magnetic sensor 4 changes when the scroll wheel 1 rotates for different angles. The at least one magnetic sensor 4 is electrically connected to a conversion control module 5. The conversion control module 5 converts a magnetic field variation and a variation rate sensed by the at least one magnetic sensor 4 into a change amount and a change speed of a control operation. Functions of the scroll wheel control system are as follows. The at least one magnetic sensor 4 is configured to acquire high-resolution rotation angle data of the scroll wheel. The conversion control module 5 is configured to calculate a scrolling speed, a scrolling direction, and a scrolling acceleration, and an operating system, such as macOS or Windows is configured to take over scrolling events and generate a customized animation curve.

In the scroll wheel control system, the at least one magnetic sensor 4 is fixed in two opposite sides of the rotating shaft 3 of the scroll wheel to collect scroll wheel rotation information in real time and transmit the scroll wheel rotation information to the conversion control module 5 via SPI or I2C protocol. After decoding the scrolling speed, the scrolling direction, and the scrolling acceleration, the conversion control module 5 sends the scrolling events to the host via Bluetooth or USB. Upon receiving the scroll wheel rotation information, the host of the macOS, Windows, or other operating system dynamically controls the scrolling animation through system interaction. The scroll wheel control system provides the at least one magnetic sensor 4 to capture signals in real time, enabling smooth animation transitions and precise scrolling responses for control of the scroll wheel, thereby accurately capturing scrolling intents of the user. Furthermore, the present disclosure eliminates any “stuttering,” “jumping,” or unnatural scrolling experience during user operation, improving a user experience for high-end office users and content creators.

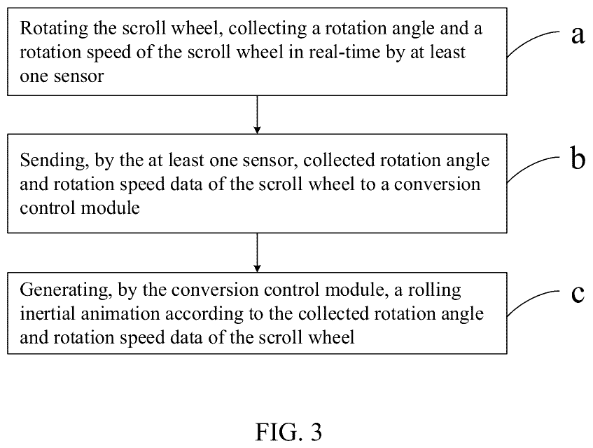

As shown in FIG. 3, a working process of the scroll wheel control system comprises steps a-c.

The step a comprises rotating the scroll wheel 1, collecting a rotation angle and a rotation speed of the scroll wheel 1 in real-time by at least one sensor 4.

The step b comprises sending, by the at least one sensor 4, collected rotation angle and rotation speed data of the scroll wheel 1 to the conversion control module 5.

The step c comprises generating, by the conversion control module 5, a scrolling inertial animation according to the collected rotation angle and rotation speed data of the scroll wheel 1.

When the user scrolls the scroll wheel, the at least one magnetic sensor 4 outputs angular displacement, speed, and acceleration signals in real time with a resolution of 1024 counts per revolution (CPR), which may also be set to 2048 CPR or higher in other applications as needed. The conversion control module 5 continuously samples and calculates an angular velocity and the scrolling acceleration, then encodes the scrolling events in a high-precision format (e.g., every 0.3°) into a scrolling signal, and sends the scrolling signal to a program on the macOS or Windows. Upon receiving the scrolling signal, the program maps a current scrolling speed to animation parameters, generates a non-linear inertial curve (such as a Bézier curve), and displays a scrolling action accordingly.

Furthermore, in one embodiment of the scroll wheel control system, the at least one magnetic sensor 4 is a Hall sensor.

The at least one magnetic sensor 4 comprises a plurality of magnetic sensors 4. The at least one magnet 2 is a magnetized ring disposed on a center of the scroll wheel 1, and the magnetized ring is matched with the plurality of magnetic sensors 4 to enhance resolution. The magnetized ring and the plurality of magnetic sensors 4 are disposed radially or axially to produce varying magnetic flux changes, thereby improving a detection capability for rotation direction and absolute angle.

In another embodiment of the scroll wheel control system, as shown in FIG. 2, the at least one magnet 2 comprises magnets evenly distributed along a circumference of the scroll wheel 1.

In one embodiment of the scroll wheel control system, to enable control on an operation end (i.e., a mouse) and eliminate the need for additional software installation on the host (i.e., a computer), a main control chip is disposed in the base. The conversion control module 5 is a functional partition within the main control chip. Alternatively, the conversion control module 5 is an additional Microcontroller Unit (MCU) electrically connected to the main control chip.

Furthermore, in one embodiment of the scroll wheel control system, the scroll wheel 1 is connected to a damping feedback device, which enables the scrolling operation to have a scrolling tactile feel.

Furthermore, in one embodiment of the scroll wheel control system, to adapt to different needs or usage habits of different groups of people, the conversion control module 5 is configured to determine a scrolling state of the scroll wheel 1 as slow/medium/fast based on the collected rotation angle and rotation speed data of the scroll wheel 1, and the conversion control module 5 is further configured to calculate the scrolling data for the scrolling state based on the scrolling parameters configured on the host.

The above describes the scroll wheel control system and the scroll wheel control method of the present disclosure to help understand the present disclosure. However, the implementation of the present disclosure is not limited to the above embodiments. Any changes, modifications, substitutions, combinations, or simplifications made without departing from the principle of the present disclosure should be considered equivalent substitutions and are comprised within the protection scope of the present disclosure.

What is claimed is:

1. A scroll wheel control system, comprising: a base;
wherein a rotating shaft is disposed on the base, a scroll wheel is rotatably disposed on the rotating shaft, at least one magnet is disposed on the scroll wheel, and at least one magnetic sensor is disposed on the base;
wherein a distance between the at least one magnet and the at least one magnetic sensor changes when the scroll wheel rotates for different angles;
wherein the at least one magnetic sensor is electrically connected to a conversion control module, and the conversion control module converts a magnetic field variation and a variation rate sensed by the at least one magnetic sensor into a change amount and a change speed of a control operation.

2. The scroll wheel control system according to claim 1, wherein the at least one magnetic sensor is a Hall sensor.

3. The scroll wheel control system according to claim 1, wherein a main control chip is disposed on the base, and the main control chip comprises the conversion control module.

4. The scroll wheel control system according to claim 1, wherein a main control chip is disposed on the base, and the main control chip is electrically connected to the conversion control module.

5. The scroll wheel control system according to claim 1, wherein the scroll wheel is connected to a damping feedback device.

6. The scroll wheel control system according to claim 1, wherein the scroll wheel is a mouse scroll wheel, and the conversion control module converts the magnetic field variation and the variation rate sensed by the at least one magnetic sensor into a movement distance and a speed of a mouse control interface.

7. A scroll wheel control method, comprising steps:
rotating the scroll wheel, collecting a rotation angle and a rotation speed of the scroll wheel in real-time by at least one sensor;
sending, by the at least one sensor, collected rotation angle and rotation speed data of the scroll wheel to a conversion control module; and
generating, by the conversion control module, a scrolling inertial animation according to the collected rotation angle and rotation speed data of the scroll wheel.

8. The scroll wheel control method according to claim 7, wherein the conversion control module uses the collected rotation angle and rotation speed data of the scroll wheel to deduce a user's intent in real time.

9. The scroll wheel control method according to claim 7, wherein the conversion control module is configured to determine a scrolling state of the scroll wheel as slow/medium/fast based on the collected rotation angle and rotation speed data of the scroll wheel, and the conversion control module is further configured to calculate scrolling data for the scrolling state based on scrolling parameters configured on a host.

10. The scroll wheel control method according to claim 7, wherein the at least one sensor is at least one magnetic sensor.
